(19) United States
(12) Patent Application Publication
(10) Pub. No.: US 2024/0289262 A1
(43) Pub. Date: Aug. 29, 2024

(54) AUTOMATIC TESTING WITH FEATURE TAGS TRAINED BY MACHINE LEARNING FOR UPDATES IN VERSION CONTROL SYSTEMS

(71) Applicant: Red Hat, Inc., Raleigh, NC (US)

(72) Inventors: Qianqian Zhu, Haidian District (CN); Leigh Griffin, Waterford (IE); Benat Garcia, Madrid (ES); Junyi Zhang, Haidian District (CN); Xu Han, Haidian District (CN)

(21) Appl. No.: 18/176,359

(22) Filed: Feb. 28, 2023

(51) Int. Cl. G06F 11/36; G06F 8/71

(52) U.S. Cl. CPC G06F 11/3688; G06F 8/71

(57) ABSTRACT

Devices, systems, methods, and techniques are disclosed herein for automatic testing with feature tags trained by machine learning for updates in version control systems. An example method includes deploying multiple updates in a code repository of a version control system and mapping the multiple updates using multiple feature labels. The multiple feature labels have been trained in a machine learning model to represent corresponding functional features. A processing device then identifies a subset of codes in the code repository. The subset of codes in the code repository is functionally affected by the multiple updates and is identified based on the multiple feature labels. The processing device performs a verification job on each of the subset of codes in the code repository in preparation for committing the multiple updates in the code repository.

### FIELD

Aspects of the present disclosure relate to management of updates in version control systems.

### BACKGROUND

A version control system (also known as revision control, source control, or source code management systems) may be a form of software repository for storing, tracking, and managing versions of a software project. Changes made to a software project can be stored in a version control system as a new version of the project such that the project can be easily rolled back to previous versions without the changes. Some software architectures, such as micro-services or other cloud platforms, may include disparate portions of software that come together to perform a larger cohesive service. Such software architectures may be stored at one or more version control systems.

Software updates stored in a version control system are typically pulled or integrated into a system continuously (e.g., by deploying updates without interrupting the operation of the system). Often times the software updates require testing before formal deployment to ensure proper operation. When the system includes a large number of components, a user may be required to perform separate test jobs separately and/or individually, which can be tremendously time consuming. Sometimes the test jobs are required to cover the entire suite and functionality of the system (with the updates), even if the updates apply only to a some or a local portion of the components. This may result in inefficient operation or wasteful use of resources (especially on the testing execution on system components that are not affected by the updates).

### SUMMARY

According to an example aspect of the present disclosure, a method provides automatic testing of update deployments. The method includes deploying multiple updates in a code repository of a version control system and mapping the multiple updates using multiple feature labels. The multiple feature labels have been trained in a machine learning model to represent corresponding functional features. A processing device then identifies a subset of codes in the code repository. The subset of codes in the code repository is functionally affected by the multiple updates and is identified based on the multiple feature labels. The processing device performs a verification job on each of the subset of codes in the code repository in preparation for committing the multiple updates in the code repository.

In one specific aspect, mapping the multiple updates using the multiple feature labels may include gathering multiple references corresponding to a first release marker of the code repository of the version control system and a second release marker of the code repository of the version control system. The multiple updates correspond to valid commits that take place between the first release marker and the second release marker. Th processing device parses the multiple references into multiple messages for extracting the multiple feature labels from the multiple messages. In some cases, parsing the multiple references into the multiple messages includes providing the multiple messages to a text processing engine; and tokenizing, by the text processing engine, the multiple messages into multiple phrases.

In some cases, identifying, by the processing device, the subset of codes in the code repository includes generating, by the machine learning model, the multiple feature labels based on the multiple phrases from the text processing engine. The multiple feature labels indicate updated functionalities corresponding to the multiple updates to be tested. In some cases, generating, by the machine learning model, the multiple feature labels based on the multiple phrases from the text processing engine includes predicting one or more new functional updates associated with the multiple updates without executing the multiple updates. The machine learning model analyzes the multiple phrases using at least one of a neural embedder or a convolutional neural network for predicting the one or more new functional updates using historical data. The one or more new functional updates may include new commits to be deployed in the code repository of the version control system.

In some cases, the method further includes providing the multiple feature labels into a dataset having additional features from other data sources. The machine learning model or an engine based on a gradient boosted tree algorithm may generate an updated set of multiple feature labels base on the dataset. The method further includes tagging, based on the updated set of multiple feature labels, new commits of the multiple updates corresponding to the subset of codes.

According to another example aspect of the present disclosure, an apparatus is provided for automatic testing of update deployments, the apparatus includes a memory and a processing device coupled to the memory. The processing device and the memory are to deploy multiple updates in a code repository of a version control system, and map the multiple updates using multiple feature labels. The multiple feature labels have been trained in a machine learning model to represent corresponding functional features. The processing device and the memory are further to identify a subset of codes in the code repository. The subset of codes in the code repository is functionally affected by the multiple updates and is identified based on the multiple feature labels. The processing device and the memory are to perform a verification job on each of the subset of codes in the code repository in preparation for committing the multiple updates in the code repository.

According to yet another example aspect of the present disclosure, a non-transitory computer-readable storage medium is provided. The computer-readable storage medium includes instructions stored thereon that, when executed by a processing device for automatic testing of update deployments, cause the processing device to deploy multiple updates in a code repository of a version control system and map the multiple updates using multiple feature labels. The multiple feature labels have been trained in a machine learning model to represent corresponding functional features. The processing device is further to identify a subset of codes in the code repository. The subset of codes in the code repository is functionally affected by the multiple updates and is identified based on the multiple feature labels. The processing device is further to perform a verification job on each of the subset of codes in the code repository in preparation for committing the multiple updates in the code repository.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram that illustrates an example system for automatic testing with feature tags trained by machine learning for updates in version control systems, in accordance with embodiments of the disclosure.

FIG. 2 is a block diagram that illustrates another example of a system for automatic testing with feature tags trained by machine learning for updates in version control systems, in accordance with embodiments of the disclosure.

FIG. 3 is a flow diagram of method for automatic testing with feature tags trained by machine learning for updates in version control systems, in accordance with embodiments of the disclosure.

FIG. 4 illustrates an example block diagram of automatic testing with feature tags trained by machine learning for updates in version control systems, in accordance with embodiments of the disclosure.

FIG. 5 illustrates an example diagram of commit feature recognition using automation algorithms, in accordance with embodiments of the disclosure.

FIG. 6 is a block diagram of an example apparatus that may perform one or more of the operations described herein, in accordance with embodiments of the disclosure.

Like numerals indicate like elements.

### DETAILED DESCRIPTION

The present disclosure provides devices, systems, methods, and techniques for automatic testing with feature tags trained by machine learning for updates in version control systems. For example, the disclosed automatic testing mechanism may identify specific features associated with updates to be deployed in a version control system and perform testing procedures in the components affected by the updates, thus saving time and resources in verifying updates.

Cloud based applications, scalable services, micro-services, and many other software applications may be developed across multiple version control systems, also referred to herein as repositories. For example, when working on a project, or multiple related projects, information may be spread across several different repositories. In some instances, a developer may debug or trace back changes that happened in one repository to similar or related changes in the same or other repositories. For example, a portion of an application may contain a bug and a developer may identify the code change (e.g., commit) that is causing the bug (e.g., an error in the code). The application may also include several other changes in other repositories that are related to the bug. The other changes related to the bug may provide context or reasons for why the bug has occurred or if similar bugs may occur elsewhere. Conventionally, to debug or trace back changes across several repositories, the developer may manually search each independent repository that includes portions of the application to identify if other changes in the repositories are related to the change causing the bug.

The present disclosure provides a mechanism that maps version updates (e.g., commits) to corresponding product feature labels for automatic testing. The version updates may include new code submissions with supporting documentations or commentaries, often for a deployment project of a version control system. As an example, the disclosed mechanism includes at least three functionality sections or blocks. First, the mechanism fetches data from the new code submissions and formats them for processing. Second, the mechanism uses a product feature label inference engine to generate corresponding feature labels to the new code submissions. Third, the mechanism maps the feature label output with corresponding test loops to be performed for verifying the affected portions in the version control system (e.g., the portions that the new code submissions may alter). By focusing on only the affected portions of the version control system, and performing the test loops automatically (as identified by the mechanism), the disclosed mechanism substantially reduces user interaction and input, thus saving time and effort.

In aspects, the present disclosure provides example methods corresponding to the mechanism for automatic testing with feature tags trained by machine learning for updates in version control systems. One example method includes labeling the updates or commits of the software with multiple feature names, corresponding to system components to be affected. The method further includes training a machine learning (ML) or artificial intelligence (AI) model to extract feature labels based on the textual information of the updates/commits. The trained ML or AI model may thus automatically label the updates/commits with correct feature names. For example, during operation, for each release (e.g., a new version) of a software, the disclosed mechanism may retrieve the commits of the release and label, using the trained ML or AI model, each of the commits. As the feature labels identify corresponding system functions or components, specific tests may be performed.

In some cases, the disclosed mechanism may be built into a continuous integration (CI), which is a software practice that frequently commits code to a shared repository. Committing codes often allows for detecting errors sooner and therefore reducing the amount of code that requires debugging when errors occur. According to the present disclosure, the CI-integrated testing mechanism is triggered upon detecting an update release (or plans for deployment). Upon committing, the mechanism identifies the feature labels of the update and automatically performs test jobs on the functionalities/features corresponding to the feature labels. For example, in some embodiments, two Jira issues (or equivalent tasks) are submitted for each functionality/feature. One of the two Jira issues may review and correct the commits, while the other Jira issue may track the test results.

In some cases, after the feature owner (e.g., a user) finishes the correction of the commits (e.g., when manual monitoring or correction is required), the feature owner may retrain the ML or AI model with the corrected data, to improve the prediction accuracy of the ML or AI model. The retrained ML or AI model may then be updated in the CI for future releases.

Embodiments of the present disclosure therefore provide advantages over conventional methods including reducing the time used to verify update deployment. Additionally, automatically triggering feature tests and locating feature specific changes may provide options for users or developers to identify limited changes (instead of testing all components in the version control system) based on the selected changes identified by ML or AI models, thus further increasing the efficiency of identifying related changes across several repositories.

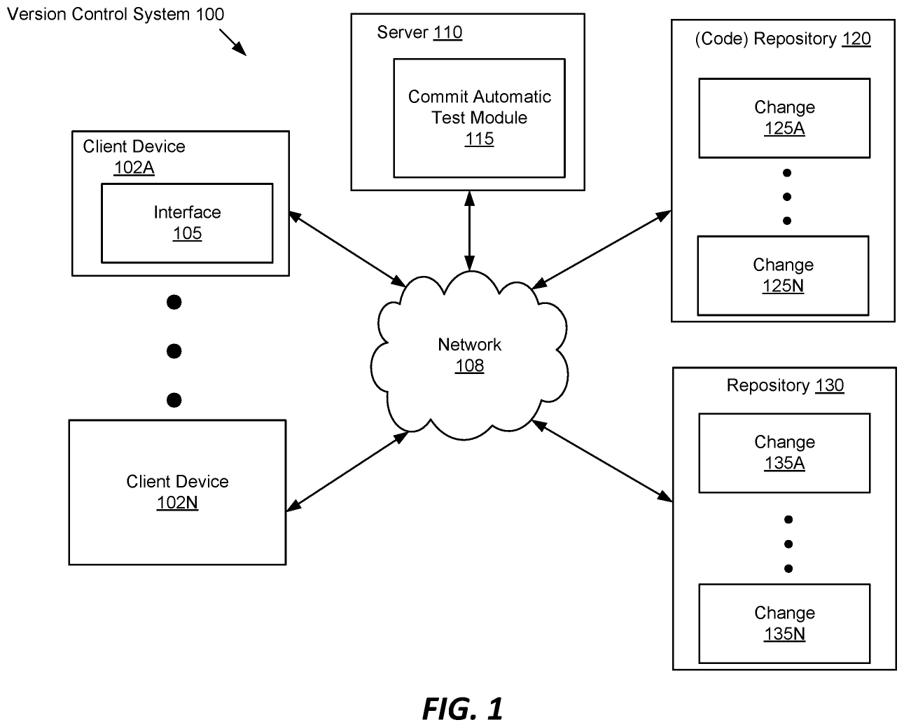

FIG. 1 is a system 100 for identifying related changes across multiple repositories. The system 100 includes one or more client devices 102A-N, one or more servers 110, and one or more repositories 120 and 130 coupled via a network 108. The network 108 may be any type of network such as a public network (e.g., the Internet), a private network (e.g., a local area network (LAN), Wi-Fi, or a wide area network (WAN)), or a combination thereof. As shown, the client devices 102A-N may be any data processing device, such as a desktop computer, a laptop computer, a mainframe computer, a personal digital assistant, a rack-mount server, a hand-held device or any other device configured to process data. The repositories 120 and 130 may each be a version control system.

In some cases, the repositories 120 or 130 may be referred to as code repositories that further includes a server repository and one or more repository working copies (not shown). During operation, one or more updates (e.g., the changes 125A-125N) may be deployed in the repositories 120 (in the server and the working copies). The updates may be referred to as commits. According to aspects to the present disclosure, the server 110 may include a commit automatic test module 115 that performs automatic testing with feature tags trained by machine learning for updates (e.g., the changes 125A-125N, and 135A-135N) to be applied in the repositories 120 and 130.

The interface 105 may be an application programming interface API, graphical user interface (GUI), or other interface that a user, such as a developer, or an application may use to perform verification testing (e.g., by executing a test suite) on updates, changes, or new commits in a repository. Instead of manually going through all components in the repository, the developer may take advantage of the disclosed mechanism to review only a subset of codes or components. In some cases, the developer may use the interface 105 to gather or add additional data for training a machine learning or artificial intelligence model that predicts functionalities affected by updates.

The server 110 may be any type of server, such as an application server, a web server, an FTP server, or any other type of server with which a user device can communicate. In one example, the server 110 hosts the commit automatic test module 115 and client devices 120A-N may interact with the commit automatic test module 115 via the server 110. Although depicted as hosted by the server 110, the commit automatic test module 115 may also be hosted at one of the repositories 120 or 130 or may execute locally at the client devices 102A-N. For example, commit automatic test module 115 may be included within an integrated development environment (IDE) (e.g., as a plugin) or as a standalone tool.

In one example, the repository 120 may include one or more changes 125A-N (e.g., commits) to at least a portion of an application stored at the repository 120. Similarly, the repository 130 may store an additional one or more changes 135A-N to another portion of the application that is stored at the repository 130. In one example, a developer/user of a client device 102A-N(e.g., a developer) may provide one or more version updates (e.g., change 125A) to the repository 120. For example, in a new version release, various functionalities of the repository 120 are to be updated or changes (usually not all functionalities are changed). The changes 125A-125N may represent respective functionality updates to corresponding components.

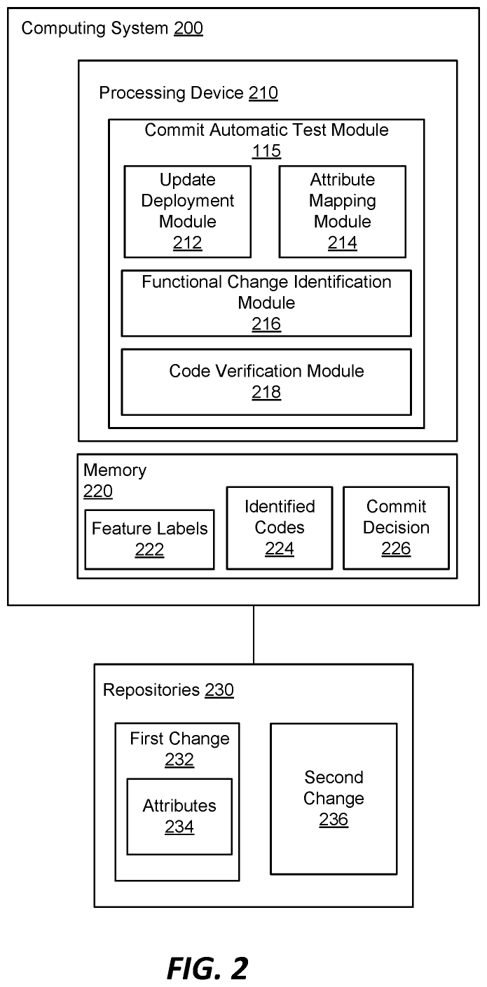

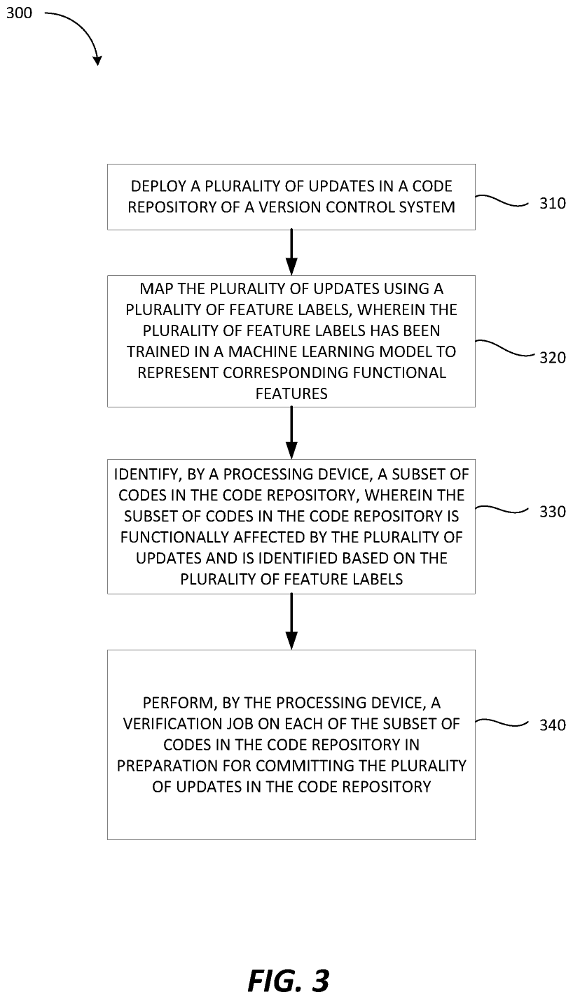

The developer/user of the client device 102A may use the commit automatic test module 115 to identify functionalities to be changed by the changes 125A-125N and to perform selective testing on the functionalities of the repository 120. The commit automatic test module 115 may then perform text processing in the repository 120, the repository 130, and any other repositories associated with the portion of the application managed by repository 120 to identify functionality changes associated with the new release deployment. Example operations are further discussed below in relation to FIGS. 2 and 3.

FIG. 2 is a block diagram illustrating a computing system 200 for related change analysis across multiple repositories, in accordance with some embodiments. The computing system 200 may include a processing device 210 and memory 220. Memory 220 may include non-transitory memory devices, such as volatile memory devices (e.g., random access memory (RAM)), non-volatile memory devices (e.g., flash memory) and/or other types of memory devices. The computer system 200 may be coupled to one or more repositories 230 for storing and managing software and versions thereof, and/or changes to the software (e.g., first change 232 and second change 236). The processing device 210 may include a commit automatic test module 115.

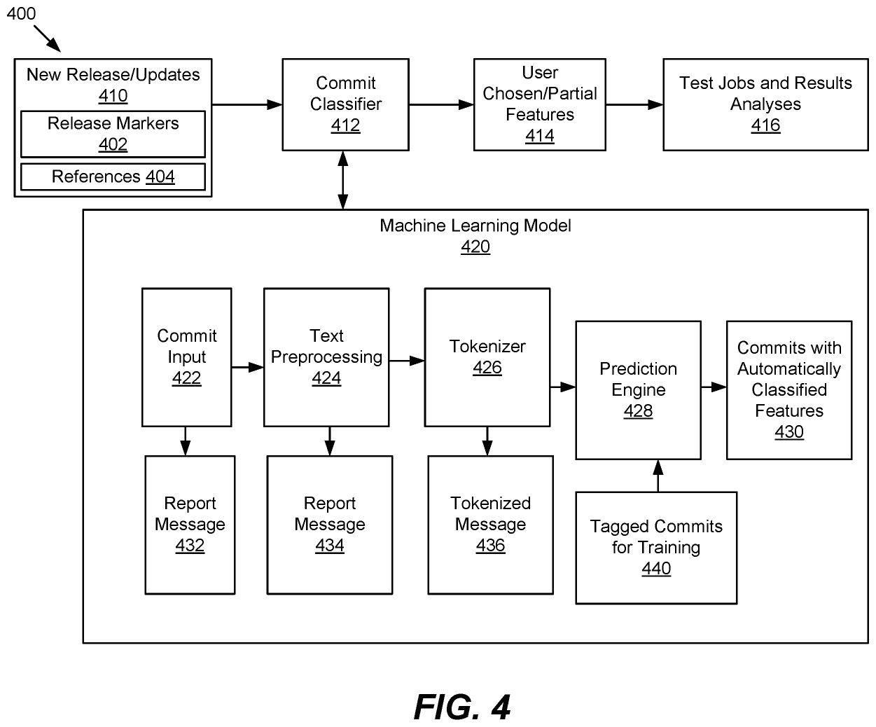

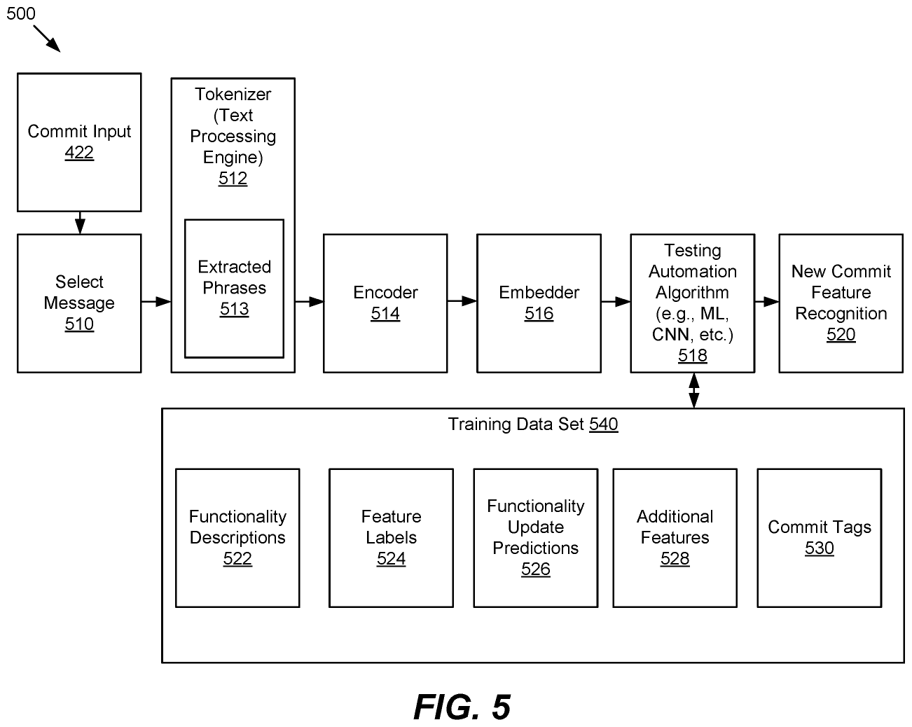

The commit automatic test module 115 may cause the processing device 210 to deploy the changes 232 or 236 in the repositories 230 (or the version control system thereof). For example, the commit automatic test module 115 includes an update deployment module 212 that detects or monitors new version releases in the repositories 230. The commit automatic test module 115 further includes an attribute mapping module 214, which maps the updates (e.g., the changes 232 and 236, collectively referred to as updates 232 and 236) using multiple feature labels 222 (e.g., stored in the memory 220). The feature labels 222 have been trained in a machine learning model (further discussed in FIGS. 4 and 5) to represent corresponding functional features identified in the updates 232 and 236.

The commit automatic test module 115 includes a functional change identification module 216, which identifies, based on the feature labels 222, a subset of codes 224 in the code repository 230. The subset of codes 224 in the code repository 230 is functionally affected by the updates 232 and 236. The commit automatic test module 115 includes a code verification module 218 that may perform a verification job on each of the subset of codes 224 in the code repository 230 in preparation for committing the updates 232 and 236 in the code repository 230. The results of the verification job may be saved in the commit decision 226, which includes corrections, if any, from the user to resolve errors or mis-labeling of the features.

In one example, the attribute mapping module 214 maps the updates 232 and 236 using the feature labels 222 using a machine learning (ML) prediction model. The ML model gathers multiple references corresponding to a first release marker (e.g., as part of the attributes 234, such as a version number) of the code repository 230 of the version control system and a second release marker (e.g., version attribute) of the code repository of the version control system.

The multiple updates 232 and 236 may correspond to valid commits (e.g., update deployments) that take place between the first release marker and the second release marker. The attribute mapping module 214 may then parse the references into multiple messages for extracting the feature labels 222 from the multiple parsed messages. For example, the messages may include author, date, code changes, statistics, and other information of the updates 232 and 236. In some cases, the attribute mapping module 214 may parse the references into the multiple messages by providing the messages to a text processing engine (e.g., the tokenizer 512 of FIG. 5) of the processing device 210.

The text processing engine may tokenize the messages into multiple phrases (e.g., “qapi,” “add,” “linaro,” etc). The phrases are used as input to the trained feature recognition algorithm, such as an ML or AI model. The algorithm may first encode the phrases into numerical representations, using a pre-trained neural network, for example. The algorithm then embeds the numerical values with words of phrases to generate an embedded matrix representation (used as an input for the next step). The algorithm applies learnable filters that convolve the input. Different sizes of the convolution may indicate different contextual analysis scopes.

Upon applying the filters, the filter may output results that are max-pooled and concatenated in the forms of vector per each layer to be provided to a neural classifier. The neural classifier then generates a binary vector representing features labeling the phrases. That is, the functional change identification module 216 may identify the subset of codes 224 by generating the feature labels 222 based on the phrases from the text processing engine. The feature labels indicate updated functionalities corresponding to the updates 232 and 236 to be tested.

In some cases, the machine learning model, generates the feature labels 222 based on the phrases from the text processing engine by predicting one or more new functional updates associated with the updates without executing the plurality of updates. That is, relying on the output from the ML or AI model to determine which components of the version control system may require testing. For example, the machine learning model analyzes the phrases using at least one of a neural embedder or a convolutional neural network (CNN) for predicting the one or more new functional updates using historical data (e.g., training data that provides sufficient determination associated feature labels with specific functionality updates).

In some cases, the one or more new functional updates (e.g., the first change 232 and the second change 236) include new commits to be deployed in the code repository 230 of the version control system. The processing device 210 and the memory 220 are further to provide the feature labels 222 into a dataset having additional features from other data sources. For example, the dataset may be used to provide training or updates to the ML or AI model (or an engine based on a gradient boosted tree algorithm). The ML or AI model may generate an updated set of feature labels based on the dataset. The ML or AI model may tag, based on the updated set of plurality of feature labels, new commits of the plurality of updates corresponding to the subset of codes.

FIG. 3 is a flow diagram of a method 300 of automatic testing with feature tags trained by machine learning for updates in version control systems, in accordance with some embodiments. Method 300 may be performed by a processing device that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 300 may be performed by the commit automatic test module 115 of FIGS. 1 and 2.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

Method 300 begins at block 310, where the processing device deploys updates in a code repository of a version control system. For example, a new version release of the code repository may correspond to updates (or commits) to be deployed.

At block 320, the processing logic maps the updates using feature labels. For example, the feature labels have been trained in a machine learning model to represent corresponding functional features of the code repository. In aspects, mapping the updates using the feature labels includes gathering a references corresponding to a first release marker of the code repository of the version control system and a second release marker of the code repository of the version control system. The updates correspond to valid commits that take place between the first release marker and the second release marker. The processing logic may parse the references into a messages for extracting the feature labels from the messages.

In some cases, parsing the references into the messages includes providing the messages to a text processing engine and tokenizing, by the text processing engine, the messages into a phrases.

At block 330, the processing logic identifies a subset of codes in the code repository. The subset of codes in the code repository is functionally affected by the updates and is identified based on the feature labels. For example, identifying the subset of codes in the code repository may include generating, by the machine learning model, the feature labels based on the phrases from the text processing engine, wherein the feature labels indicate updated functionalities corresponding to the updates to be tested.

In some aspects, generating, by the machine learning model, the feature labels based on the phrases from the text processing engine includes predicting one or more new functional updates associated with the updates without executing the updates. The machine learning model analyzes the phrases using at least one of a neural embedder or a convolutional neural network for predicting the one or more new functional updates using historical data. In some cases, the one or more new functional updates include new commits to be deployed in the code repository of the version control system.

At block 340, the processing logic performs a verification job on each of the subset of codes in the code repository in preparation for committing the updates in the code repository.

In aspects, the processing logic further provides the feature labels into a dataset having additional features from other data sources. The machine learning model (or an engine based on a gradient boosted tree algorithm) may generate an updated set of feature labels base on the dataset. The machine learning model ma tag, based on the updated set of feature labels, new commits of the updates corresponding to the subset of codes. The updated machine learning model may improve the prediction accuracy in view of the updated set of feature labels.

FIG. 4 illustrates an example block diagram 400 of automatic testing with feature tags trained by machine learning for updates in version control systems, in accordance with embodiments of the disclosure. The operations in the block diagram 400 may be performed by the commit automatic test module 115 of the processing device 210 of FIG. 2. As shown, upon detecting a new release (or version updates) 410, the commit automatic test module may process the new release 410 in a commit classifier 412 to identify affected functionalities.

In some cases, the detection of the new release 410 is based on the release markers 402 and/or the references 404 therein. For example, the commit automatic test module may compare release markers to determine whether an update is valid (e.g., a subsequent version or an outdated version). In some cases, the commit automatic test module parses the references 404 to extract feature labels from the new release 410 by providing them to the commit classifier 412 (e.g., generally referred to as a text processing engine), which tokenizes the references 404 into phrases for subsequent prediction procedures. During operation, the commit automatic test module gathers references 404 of the updates/commits 410 that fall between two testable release markers 402 (which may be date based or version based), thereby identifying all valid commits. By parsing the commit message, the commit automatic test module obtains the metadata such as author, message, code changes, format, depth, etc.

The commit classifier 412 is an inference engine that processes the parsed commit message, such as by preprocessing the texts. At a high level, a user may define, for a repository, feature names and divide testing specifications into test jobs based on the feature names, such that each feature corresponds to one test job or suite. As shown, the commit classifier 412 may use a machine learning model 420 to process the information obtained from the new release 410. The machine learning model 420 is trained with previous commit input 422 and associated feature extraction or labeling results. For example, the machine learning model 420 uses report messages 432 that include prior user-corrected functionality association with the commit input 422 for training association prediction for future commit phrases.

Similarly, the machine learning model 420 may also include a text processing module 424 that parses the commit input 422 and identifies associations with results recorded in the report message 434. The machine learning model 420 further includes a tokenizer 426 that splits the preprocessed texts from the text processing module 424 (the splitting operation may be trained using prior tokenized messages 436). The machine learning model 420 includes a prediction engine 428, which may be based on an AI system such as a neural embedder and convolutional neural network that effectively generates a fine-tuned model to identify components or functionalities affected by the new release 410. The fine-tuned model may include a domain specific model for this particular software or component. Once trained, as complimented by training on historical recorded data such as the tagged commits 440 used for training (which may come from other repositories or version control systems), the machine learning model 420 may accurately predict the automatically classified features 430 affected by the new release 410.

When the tokenizer 426 processes the phrases, the tokenized text may be converted into a set of features using a tf-idf embedder on each of the text inputs (one for the commits, one for the code changes). The set of features is fed into a dataset with additional qualitative and quantitative features from additional data sources to complement the feature identification process performed by the prediction engine 428. In some cases, the prediction engine 428 may use a gradient boosted tree algorithm (xgboost) that is trained for precision and recall to perform the classification operations.

As new commits are tagged using the derived functionality feature tags by the machine learning model 420, a one-to-one mapping between test cases and functionality affected capable between features and test cases can be produced and used for automatic testing. In some cases, the automatically classified features 430 may be changed or updated based on user review. For example, a user may further include or reduce identified features into a set of user chosen/partial features 414, subject to verification testing by the test job and results analyses 416. A user or developer may then run targeted tests that only impact the functionalities or features affected by the new release 410, instead of executing overall tests that apply to the repository as a whole. In some cases, the machine-learning based commit classifier 412 has been successfully deployed within qemu-kvm and has achieved a 40% reduction in user labor time and hardware resources on running the verification tests.

FIG. 5 illustrates an example diagram 500 of commit feature recognition using automation algorithms, in accordance with embodiments of the disclosure. In aspects, the example diagram 500 is an alternative representation of operations of the machine learning model 420 of FIG. 4. The difference includes specific modules of the encoder 514, the embedder 516, alternative testing automation algorithm 518, and additional details on the training data set 540. Similar to the discussion of FIG. 4, the commit input 422 is processed into select messages 510 for feeding to the tokenizer 512, which then extracts feature related phrases 513 and provides the feature related phrases 513 to the encoder 514.

In some cases, the tokenizer 512 may regularize texts (to use a common set of cases, such as lowercase, accents, etc.) and split the texts into tokens by a regular expression. As such, the tokenizer 512 may reduce the tokens into the respective stems (e.g., “gensim.parsing.preprocessing.preprocess_string”). The encoder 514 may then encode the split texts with indices or numerical representations. The embedder 516 then turns the encoded texts into numerical representations using a pre-trained neural network (e.g., “gensim.downloader.load(“glove-wiki-gigaword-100”)” and initialize a torch.nn. embedding with the numerical values).

The testing automation algorithm 518 may include a convolutional neural network (CNN) to predict features based on the input from the embedder 516. For example, the CNN may apply learnable filters that convolve the input. The filters may output results that are max-pooled and concatenated (e.g., a vector per each layer). In some cases, the CNN is trained using the training data set 540, which includes functionality descriptions 522 of prior updates or commits, the corresponding feature labels 524 (e.g., verified and accurate), recent functionality update predictions 526, additional features 528, and commit tags 530.

During operation, the test automation algorithm 518 may use a number of perceptrons that is equal to a number of feature labels. Each perceptron may give a probability of a commit that affects a specific functionality or class. The test automation algorithm 518 may apply a threshold to generate a binary vector matching feature labels (e.g., the commit tags 530) to the numerical representations from the embedder 516. The testing automation algorithm 518 then outputs the results of predicted or recognized commit features 520. Although FIG. 5 provides specific examples of the training data set 540 and the testing automation algorithm 518, other similar or functionally equivalent data sets or algorithms may be used to perform the operations disclosed herein.

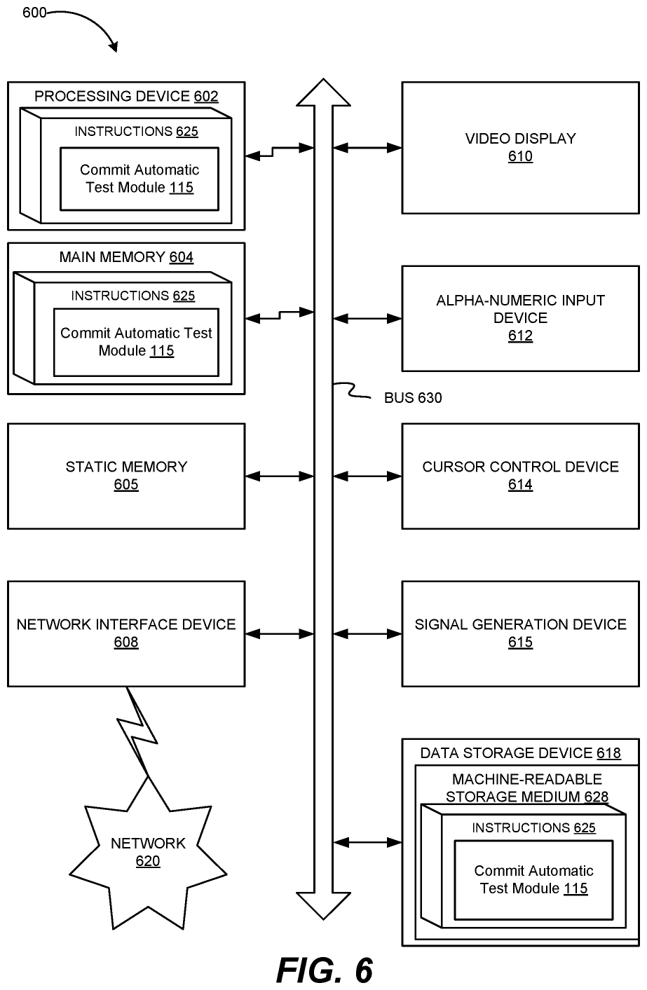

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 605 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 615 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a repository search module, e.g., the commit automatic test module 115, for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of automatic testing of update deployments, the method comprising:
deploying a plurality of updates in a code repository of a version control system;
mapping the plurality of updates using a plurality of feature labels, wherein the plurality of feature labels has been trained in a machine learning model to represent corresponding functional features;
identifying, by a processing device, a subset of codes in the code repository, wherein the subset of codes in the code repository is functionally affected by the plurality of updates and is identified based on the plurality of feature labels; and
performing, by the processing device, a verification job on each of the subset of codes in the code repository in preparation for committing the plurality of updates in the code repository.

2. The method of claim 1, wherein mapping the plurality of updates using the plurality of feature labels comprises:
gathering a plurality of references corresponding to a first release marker of the code repository of the version control system and a second release marker of the code repository of the version control system, wherein the plurality of updates corresponds to valid commits that take place between the first release marker and the second release marker; and
parsing the plurality of references into a plurality of messages for extracting the plurality of feature labels from the plurality of messages.

3. The method of claim 2, wherein parsing the plurality of references into the plurality of messages comprises:
providing the plurality of messages to a text processing engine; and
tokenizing, by the text processing engine, the plurality of messages into a plurality of phrases.

4. The method of claim 3, wherein identifying, by the processing device, the subset of codes in the code repository comprises:
generating, by the machine learning model, the plurality of feature labels based on the plurality of phrases from the text processing engine, wherein the plurality of feature labels indicates updated functionalities corresponding to the plurality of updates to be tested.

5. The method of claim 4, wherein generating, by the machine learning model, the plurality of feature labels based on the plurality of phrases from the text processing engine comprises:
predicting one or more new functional updates associated with the plurality of updates without executing the plurality of updates, wherein the machine learning model analyzes the plurality of phrases using at least one of a neural embedder or a convolutional neural network for predicting the one or more new functional updates using historical data.

6. The method of claim 5, wherein the one or more new functional updates comprise new commits to be deployed in the code repository of the version control system.

7. The method of claim 5, further comprising:
providing the plurality of feature labels into a dataset having additional features from other data sources;
generating, by the machine learning model or an engine based on a gradient boosted tree algorithm, an updated set of plurality of feature labels base on the dataset; and
tagging, based on the updated set of plurality of feature labels, new commits of the plurality of updates corresponding to the subset of codes.

8. An apparatus for automatic testing of update deployments, the apparatus comprising:
a memory; and
a processing device coupled to the memory, the processing device and the memory to:
deploy a plurality of updates in a code repository of a version control system;
map the plurality of updates using a plurality of feature labels, wherein the plurality of feature labels has been trained in a machine learning model to represent corresponding functional features;
identify a subset of codes in the code repository, wherein the subset of codes in the code repository is functionally affected by the plurality of updates and is identified based on the plurality of feature labels; and
perform a verification job on each of the subset of codes in the code repository in preparation for committing the plurality of updates in the code repository.

9. The apparatus of claim 8, wherein to map the plurality of updates using the plurality of feature labels is to:
gather a plurality of references corresponding to a first release marker of the code repository of the version control system and a second release marker of the code repository of the version control system, wherein the plurality of updates corresponds to valid commits that take place between the first release marker and the second release marker; and
parse the plurality of references into a plurality of messages for extracting the plurality of feature labels from the plurality of messages.

10. The apparatus of claim 9, wherein to parse the plurality of references into the plurality of messages is to:
provide the plurality of messages to a text processing engine; and
tokenize, by the text processing engine, the plurality of messages into a plurality of phrases.

11. The apparatus of claim 10, wherein to identify the subset of codes in the code repository is to:
generate, by the machine learning model, the plurality of feature labels based on the plurality of phrases from the text processing engine, wherein the plurality of feature labels indicates updated functionalities corresponding to the plurality of updates to be tested.

12. The apparatus of claim 11, wherein to generate, by the machine learning model, the plurality of feature labels based on the plurality of phrases from the text processing engine is to:
predict one or more new functional updates associated with the plurality of updates without executing the plurality of updates, wherein the machine learning model analyzes the plurality of phrases using at least one of a neural embedder or a convolutional neural network for predicting the one or more new functional updates using historical data.

13. The apparatus of claim 12, wherein the one or more new functional updates comprise new commits to be deployed in the code repository of the version control system.

14. The apparatus of claim 12, wherein the processing device and the memory are further to:
provide the plurality of feature labels into a dataset having additional features from other data sources;
generate, by the machine learning model or an engine based on a gradient boosted tree algorithm, an updated set of plurality of feature labels base on the dataset; and
tag, based on the updated set of plurality of feature labels, new commits of the plurality of updates corresponding to the subset of codes.

15. A non-transitory computer-readable storage medium having instructions stored thereon that, when executed by a processing device for automatic testing of update deployments, cause the processing device to:
deploy a plurality of updates in a code repository of a version control system;
map the plurality of updates using a plurality of feature labels, wherein the plurality of feature labels has been trained in a machine learning model to represent corresponding functional features;
identify a subset of codes in the code repository, wherein the subset of codes in the code repository is functionally affected by the plurality of updates and is identified based on the plurality of feature labels; and
perform a verification job on each of the subset of codes in the code repository in preparation for committing the plurality of updates in the code repository.

16. The non-transitory computer-readable storage medium of claim 15, wherein to map the plurality of updates using the plurality of feature labels is to:
gather a plurality of references corresponding to a first release marker of the code repository of the version control system and a second release marker of the code repository of the version control system, wherein the plurality of updates corresponds to valid commits that take place between the first release marker and the second release marker; and
parse the plurality of references into a plurality of messages for extracting the plurality of feature labels from the plurality of messages.

17. The non-transitory computer-readable storage medium of claim 16, wherein to parse the plurality of references into the plurality of messages is to:
provide the plurality of messages to a text processing engine; and
tokenize, by the text processing engine, the plurality of messages into a plurality of phrases.

18. The non-transitory computer-readable storage medium of claim 17, wherein to identify the subset of codes in the code repository is to:
generate, by the machine learning model, the plurality of feature labels based on the plurality of phrases from the text processing engine, wherein the plurality of feature labels indicates updated functionalities corresponding to the plurality of updates to be tested.

19. The non-transitory computer-readable storage medium of claim 18, wherein to generate, by the machine learning model, the plurality of feature labels based on the plurality of phrases from the text processing engine is to:
predict one or more new functional updates associated with the plurality of updates without executing the plurality of updates, wherein the machine learning model analyzes the plurality of phrases using at least one of a neural embedder or a convolutional neural network for predicting the one or more new functional updates using historical data.

20. The non-transitory computer-readable storage medium of claim 19, wherein the one or more new functional updates comprise new commits to be deployed in the code repository of the version control system.
